(19) United States
(12) Patent Application Publication
(10) Pub. No.: US 2012/0042109 A1
(43) Pub. Date: Feb. 16, 2012

(54) CONNECTOR ELEMENT FOR A COMMUNICATION SYSTEM AND COMMUNICATION BUS SYSTEMS

(76) Inventors: Johannes Schier, Oberstenfeld (DE); Robert Kornhaas, Spraitbach (DE)

(21) Appl. No.: 13/198,923

(22) Filed: Aug. 5, 2011

(30) Foreign Application Priority Data
Aug. 11, 2010 (DE) 102010039177.8

(51) Int. Cl. G06F 13/14

(52) U.S. Cl. 710/305

(57) ABSTRACT

A connector element for assembling a communication system, having a plurality of communication bus system contact elements for connecting to a communication bus system, a plurality of internal terminal elements and a configuration encoding unit. The connector element is designed for assembling the communication bus system.

### FIELD OF THE INVENTION

The present invention is directed to a connector element for assembling a communication system as well as a communication bus system.

### BACKGROUND INFORMATION

An electrical/electronic architecture (E/E architecture) describes the structure of a vehicle electrical and electronic system, for example, in a passenger car or truck.

Present-day E/E architectures connect, for example, control units and sensors in a motor vehicle and make it possible for various electronic components in a vehicle to communicate. A bus connection or a communication bus structure connects individual elements of the communication system which ultimately access the common bus and communicate with one another using the common bus.

However, conventional bus structures may need, for example, a splice in a cable harness or control unit coupling elements, for example, control unit pins, for making possible an electrically conductive connection or coupling to the bus and accordingly its conducting elements, for example, cables of a cable harness. This may, however, simultaneously result in an increase of a conductor length of the conducting elements of a bus structure.

Individual elements or electronic components, for example, may not have a biunique marking for biuniquely identifying a component to be connected to the bus with regard to relevant parameters.

Likewise, a biunique marking may not be provided to identify whether a component to be connected to the bus has the function of an intermediate piece or an end piece. In the case of an intermediate piece, the bus, in particular, may be continued, while an end piece terminates a bus, for example, via a terminating resistor.

For example, in the case of the peripheral sensor interface (PSI 5), no biunique marking regarding the type of the bus connection, a communication frequency or, if necessary, a sensor type to be connected, may be possible. In the case of a controller area network (CAN), both additional control unit contact elements or control unit pins as well as terminating resistors may possibly be held available in a control unit, although both elements are never needed in the same device.

### SUMMARY OF THE INVENTION

Accordingly, a connector element is provided for assembling a communication bus system, having a plurality of communication bus system contact elements for connecting to a communication bus system, a plurality of internal connecting elements and a configuration encoding unit, in which the connector element is equipped for assembling the communication bus system.

Furthermore, a communication bus system is provided, having a control unit, at least one first connector element, having four communication bus system contact elements and a second connector element, having two communication bus system contact elements, the control unit, the at least one first connector element and the second connector element being connected operationally in such a way that they are able to communicate with one another.

The connector element according to the present invention is thus equipped as an integral component for assembling the bus system itself. A connection is made to not only a bus system, but instead the connector element itself is equipped for assembling the communication bus system successively. This is achieved in particular in that the connector element according to the present invention is not applied to a parallel pickup of the conducting elements of the bus system but instead it is made possible for the bus system itself to be looped through the connector element due to the design having four communication bus system contact elements.

Thus the connector element according to the present invention does not require a predefined or prefabricated bus wiring system, for example, in a cable harness of a vehicle, but may instead assemble the bus system independently section by section by stringing together individual connector elements having conductors or cable sections lying between them.

If an assembly of a communication bus system is thus discussed in the context of the present invention, this is to be understood as the successive, strung together interconnection of individual connector elements which in their totality constitute the communication bus system.

The connector element may have proprietary or standardized plug connector formats for a particular desired bus system or bus protocol, and thus a particular connector element type adapted to the desired bus system.

The connector element according to the present invention thus has a mechanical and/or electrical expansion and encoding. A differentiation is made in this connection between two different connector elements, and thus an intermediate connector element or intermediate piece and an end connector plug element or end piece.

In the case of the intermediate piece, looping through or daisy chaining takes place in the connector element itself. Thus the intermediate piece provides in particular four communication bus system contact elements or four conductors in the direction of the bus system for coupling the connector element to the bus system and looping it through the bus system. Furthermore, two internal connecting elements or two couplers, for example, female or male couplers, to which a sensor element may be connected, may be provided in the direction of an element to be connected, for example, a sensor element in the intermediate piece.

In the case of an end piece, two communication bus system contact elements in particular may be present in the direction of the bus system as well as two internal connecting elements in the direction of an element to be connected, for example, a sensor element or a terminating resistor element.

A mechanical, optical or electrical encoding may be used on or in the plug connector in particular for avoiding a mix-up of connector elements. In the case of a PSI 5 bus system, an encoding of sensor type or communication configuration may be made, while in the case of a CAN bus system, an encoding may be made as to whether a bus terminating resistor element is integrated in a connector element or an end piece. Furthermore, an E/E architecture topology may be encoded generally or a delay time according to a sync pulse may also be encoded in a bus system for special applications.

In the connector element according to the present invention, it may in particular be unnecessary to provide an option for looping through on a control unit, i.e., provision of a daisy chain. This may make it possible to save at least two contact elements or pins per sensor; furthermore, material cost is reduced in the control unit plug connector and in the printed board surface. This may result in a standardization of control units by reducing the large number of variants, since no differentiation is necessary in particular in equipping the control unit or in the bus network topology.

It may be possible to avoid providing terminating resistors which may possibly not be needed in individual elements, since they are positioned as an intermediate piece and not as an end piece, this also resulting in reducing the necessary printed board surface, making possible an optimization in the plug connector area.

In particular, a visual or optical encoding in an optically visible plug connector area may be used as a distinguishing feature, for example, in a service case in order to be able to exchange a defective device for a replacement device quickly without, for example, having to inspect the device for conclusively determining the type of device.

This results in error avoidance, for example, by connecting a wrong connector element, due to a biuniqueness of the connection between the terminal element, connector element or sensor element and the communication matrix according to a key and lock principle. A message catalog including the relevant transmitters and receiver is understood in particular to be a communication matrix. This may also make it possible to implement a standardization of a connection to a cable harness for connector elements, which may also ensure simple interchangeability. The use of plugs in the connector element, which are specifically adapted to or standardized for individual bus systems, i.e., the communication bus system contact elements, may be necessary or preferred.

The connector element may be essentially made up of the actual plug connector contacts or communication bus system contact elements, which in the case of the intermediate piece may be designed in duplicate, making it possible for the bus to be looped through the connector element, resulting in the implementation of daisy chaining.

Furthermore, the connector element may have in particular a mechanical configuration bar which is injection molded or applied to the connector element and having, for example, a housing.

A counterpart which is configured for accommodating the connector element may have a counterpart for the configuration bar, which may likewise be configured accordingly, for example mechanically. The encoding of the connector element, for example, via raises or indentations of the configuration bar, makes it possible to ensure that a corresponding connector element may be attached exclusively to the particular counterpart or receiving element which is configured for responding to the connector element. Likewise it may be ensured that only a matching or desired connector element may be attached at a specific position in a vehicle.

Thus, for example, a specific sensor element type may be defined via the configuration bar which may only be plugged onto a specific receiver which is designed for this sensor element type.

In the case of a CAN bus, it is possible to use the configuration bar to mechanically encode the degree to which an end piece contains a terminating resistor. In particular in the case of the CAN bus, the intermediate piece and the end piece may thus differ exclusively in that the end piece has a terminating resistor while the intermediate piece does not have it. Other mechanical and/or electrical parameters may be identical between the end piece and intermediate piece in the case of a CAN bus.

The configuration bars thus make it possible to obtain a biunique assignment of the connector element to the sensor element type, communication type and end piece and intermediate piece.

The connector element according to the present invention is usable for a large number of bus systems, for example PSI 5, CAN, FlexRay and DSI.

### BRIEF DESCRIPTION OF THE DRAWINGS

FIGS. 1a and 1b show an exemplary specific embodiment of an intermediate piece and an end piece according to the present invention.

FIG. 2 shows an exemplary specific embodiment of a communication bus system according to the present invention.

FIGS. 3a, 3b and 3c show exemplary embodiments of a communication configuration and a sensor type configuration according to the present invention.

### DETAILED DESCRIPTION

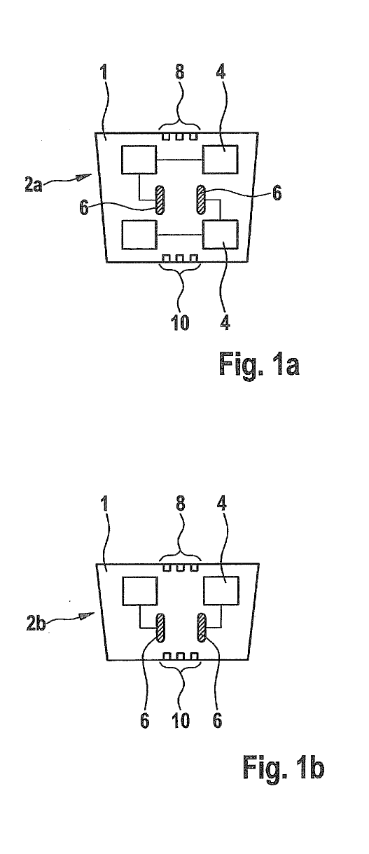

FIGS. 1a and 1b show an exemplary specific embodiment of an intermediate piece and an end piece according to the present invention.

FIG. 1a shows intermediate piece 2a. Intermediate piece 2a has, for example, a total of four communication bus system contact elements 4 and two internal terminal elements 6.

Two communication bus system contact elements 4 are in each case directly connected to one another and thus implement a daisy chaining or a looping through within intermediate piece 2a.

Communication bus system contact elements 4 may be implemented by standardized connecting elements such as pins or contact springs, which are situated, for example, on one surface of a housing 1 projecting to the outside. Internal terminal elements 6 make it possible to connect a sensor element, for example.

Furthermore, configuration bars 8, 10 are applied to the surface of housing 1. Configuration bars 8, 10 may in this case be implemented purely optically, for example, by a color marking, mechanically by a raise or lowered indentation of the particular bar parts or electrically by conductive contacts. Both communication configuration plug connector bar 8 and sensor type configuration plug connector bar 10 are shown as examples in FIG. 1a having three individual elements which make possible a binary encoding of individual configurations and are thus able to differentiate between eight possible configurations in the case of three elements.

In the case of a mechanical encoding, the individual elements of configuration bars 8, 10 may be geometrically distinctly formed, for example, rectangular, raises and indentations in housing surface 1, which, in the case of being plugged onto a terminal element, engage in corresponding indentations and raises on the terminal element. This may ensure that only with a matching system of raises and indentations on connector element 2a, b and indentations and raises on the terminal element a plug-on may be implemented, which subsequently makes electrical contacting of the communication bus system contact elements with the communication bus system possible in the first place.

An end piece 2b of a connector element according to the present invention is represented in FIG. 1b.

According to FIG. 1b, connector element 2b has two communication bus system contact elements 4 and thus prevents the bus from being looped through connector element 2b. Two internal terminal elements 6 are provided on communication bus system contact elements 4. In the case of the end piece, sensor elements may also be situated between internal terminal elements 6 of end piece 2b, or also in the case that a communication bus terminating resistor is needed, it may be connected between internal terminal elements 6.

Configuration bars for communication configuration 8 and sensor type configuration 10 correspond to the configuration bars of connector element 2a according to FIG. 1a.

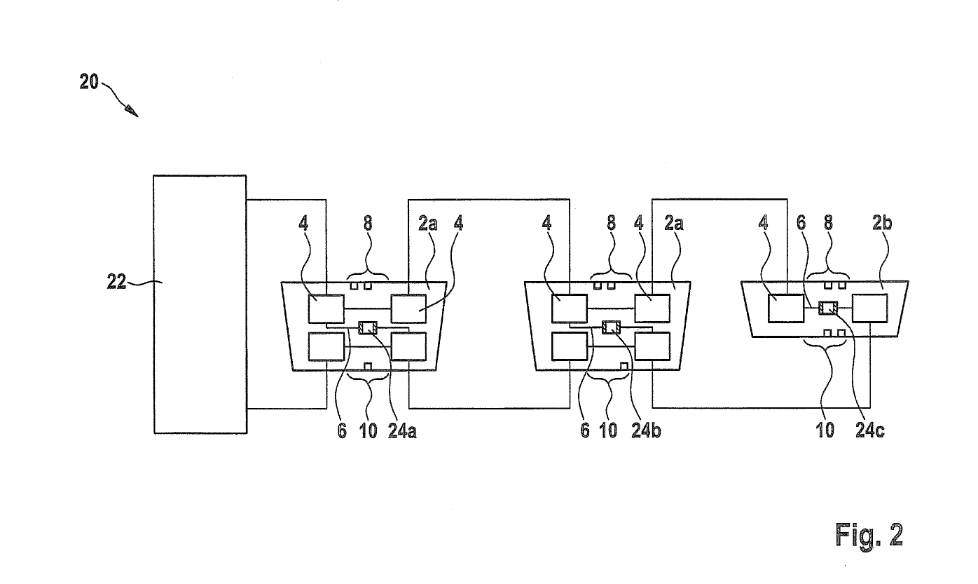

With further reference to FIG. 2, an exemplary specific embodiment of a communication bus system according to the present invention is represented.

FIG. 2 shows a communication bus system 20 as an example having a control unit 22, two intermediate pieces 2a and an end piece 2b. Intermediate pieces 2a are represented in their looping through or daisy chaining configuration, while on the other hand, end piece 2b is embodied as such and has only two communication bus system contact elements 4.

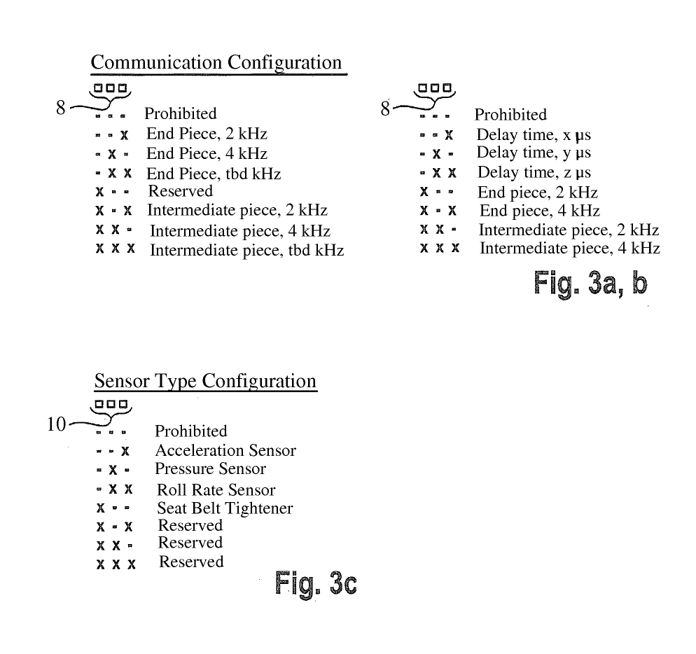

According to communication configuration bar 8, both intermediate pieces 2a are configured as intermediate pieces at 4 kHz (see FIG. 3). End piece 2b is in turn encoded as an end piece via communication configuration bar 8. A sensor type which is situated as sensor element 24a, b, c between internal terminal elements 6 may be encoded via the second configuration bar, for example, a sensor type configuration bar 6. A pressure sensor may be encoded in the case of first intermediate piece 2a, an acceleration sensor may be encoded in the case of the second intermediate piece 2a and a roll rate sensor may be encoded in the case of end piece 2b (see FIG. 3).

As a function of the design of the communication bus, a bus terminating resistor element may also be situated in end piece 2b as element 24c.

As represented in FIG. 2, a bus system may thus be built up successively by stringing together connector elements 2a, b according to the present invention having a looping through function without having to provide a prefabricated cable length between individual connector elements 2a, b, since they may make use of individual cable lengths between the individual connector elements, for example, due to their daisy chaining functionality.

Exemplary embodiments of the communication configuration and the sensor type configuration according to the present invention are represented in FIGS. 3a-3c and are thus possible configurations or equivalents of communication configuration bars 8 and sensor type configuration bar 10.

The shown frequency in this connection expresses events per unit of time which are transmitted by the communication channel, i.e., the bus clock.

As a function of the bus type, a differentiation may be made in communication configuration bar 8 between the end piece and the intermediate piece in different frequencies, or a differentiation may be made between, for example, end piece/intermediate piece as well as a delay time.

The sensor type configuration may, for example, differentiate between an acceleration sensor, a pressure sensor, a roll rate sensor and a seat belt tightener.

In the encoding of configuration bars 8, 10, dashes “-” may be understood as a non-depicted element, while “x” may be understood as a depicted element, for example, a mechanical raise or indentation in the housing, a color marking or a conductive contact. The relation between dashes “-” and “x” may also be reversed.

What is claimed is:

1. A connector element for assembling a communication system, comprising:
a plurality of communication bus system contact elements for connecting to a communication bus system;
a plurality of internal terminal elements; and
a configuration encoding unit,
wherein the connector element is equipped for assembling the communication bus system.

2. The connector element according to claim 1, wherein at least one of (a) the connector element has two or four communication system contact elements and (b) the connector element has two internal terminal elements.

3. The connector element according to claim 1, wherein the internal terminal elements are designed for connecting an element from the group made up of a sensor element, a resistor element and a communication bus system terminating resistor element.

4. The connector element according to claim 1, wherein the connector element is designed for connecting to and assembling of a bus system from the group made up of a peripheral sensor interface, a controller area network, a FlexRay and a digital serial interface.

5. The connector element according to claim 1, wherein the connector element has four communication system contact elements which are designed for looping the communication bus system through the connector element.

6. The connector element according to claim 1, wherein the configuration encoding unit is designed for the electrical, mechanical and/or visual encoding of a property of the connector element.

7. The connector element according to claim 1, wherein the configuration encoding unit is designed for encoding a sensor type, a communication configuration, an electrical-electronic topology, a delay time according to a sync pulse and/or a connector element type.

8. A communication bus system, comprising:
a control unit;
at least one first connector element including four communication bus system contact elements; and
a second connector element including two communication bus system contact elements,
wherein the control unit, the at least one first connector element and the second connector element are connected operationally in order to be able to communicate with one another.
